(19) United States
(12) Patent Application Publication
(10) Pub. No.: US 2025/0328447 A1
(43) Pub. Date: Oct. 23, 2025

(54) METHOD AND SYSTEM FOR DETERMINING USER ENGAGEMENT BASED ON USER INTERACTIONS

(71) Applicant: Trayport Limited, London (GB)

(72) Inventors: Elliot Pickard, London (GB); Michael Alexander Cowley, London (GB); Stephen Marcantonio, London (GB)

(21) Appl. No.: 18/643,175

(22) Filed: Apr. 23, 2024

(51) Int. Cl. G06F 11/34; G06Q 40/04

(52) U.S. Cl. CPC G06F 11/3438; G06F 3/0481; G06F 9/451; G06Q 40/04

(57) ABSTRACT

Disclosed is a method for determining user engagement based on user interactions. The method comprising collecting via a communication network (304), user-interaction data representative of the user interactions of a plurality of users with a graphical user interface (GUI) (204, 306) executed at a corresponding plurality of user devices (202A-C, 308A-F); analyzing the user-interaction data to determine an aggregate user activity within the GUI; and displaying an indication of the aggregate user activity within the GUI to a given user at a given user device (308F) from amongst the corresponding plurality of user devices, for determining the user engagement.

### TECHNICAL FIELD

The present disclosure relates to methods for determining user engagements through graphical user interface interactions. Moreover, the present disclosure relates to systems for determining user engagements through graphical user interface interactions.

### BACKGROUND

Generally, trading platforms serve as digital interfaces that facilitate buying and selling of physical and financial instruments, and derivatives thereof, such as bonds, commodities and derivatives. Traders need to register on the trading platform and set up trading accounts which provides access to various financial markets, allowing the traders to trade or receive price information over a wide range of instruments. The trading platforms receive real-time market data feeds including price quotes, bid- ask spreads, trading volume and other relevant information.

However, existing solutions for the trading platforms suffer from high latency issues that can lead to delayed trade confirmation and impact the accuracy of transactions in real-time. Moreover, trading platforms provide market insights on the basis of a trader's own data and history of trade. The user's own trade data or the data provider's perspective impacts the accuracy of the future insights related to the market and affects the efficient and profitable decision making by the users. Moreover, the existing solutions for the trading platforms are unable to provide personalized support and tailored assistance to the traders, on the basis of specific real-time demand from the traders. Furthermore, the present trading platforms face challenges in maintaining sufficient liquidity, affecting an execution of large orders at desired prices.

Therefore, in light of the foregoing discussion, there exists a need to overcome the aforementioned drawbacks.

### SUMMARY

The aim of the present disclosure is to provide a method and a system to assess a user engagement based on user interactions and display an indication of an aggregate user activity at a given user device. The aim of the present disclosure is achieved by a method and a system for determining user engagement based on user interactions as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 is an illustration of a flowchart depicting steps of a method for determining user engagement based on user interactions, in accordance with an embodiment of the present disclosure;

FIG. 2 is a schematic illustration of an implementation of a method for determining user engagement based on user interactions, in accordance with an embodiment of the present disclosure; and

FIG. 3 is an illustration of a system for determining user engagement based on user interactions, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a method for determining user engagement based on user interactions, comprising:
collecting via a communication network, user-interaction data representative of the user interactions of a plurality of users with a graphical user interface (GUI) executed at a corresponding plurality of user devices;
analyzing the user-interaction data to determine an aggregate user activity within the GUI; and
displaying an indication of the aggregate user activity within the GUI to a given user at a given user device from amongst the corresponding plurality of user devices, for determining the user engagement.

The present disclosure provides an aforementioned method that improves an efficiency in determining the user engagement based on the user interactions. Moreover, displaying the indication of the aggregate user activity provides in-depth analysis and insights to the given user in a simplified manner. Furthermore, determining the user engagement based on the indication of the aggregate user activity enhances the user experience of the given user by enabling the given user to make improved decision making based on the indication of the aggregate user activity displayed, outputted or communicated via other means, such as through sound or API, to the given user.

In a second aspect, the present disclosure provides a system for determining user engagement based on user interactions, comprising a server arrangement configured to:
collect via a communication network, user-interaction data representative of the user interactions of a plurality of users with a graphical user interface (GUI) executed at a corresponding plurality of user devices;
analyze the user-interaction data to determine an aggregate user activity within the GUI; and
display an indication of the aggregate user activity within the GUI to a given user at a given user device from amongst the corresponding plurality of user devices, to determine the user engagement.

The present disclosure provides an aforementioned system that improves the efficiency in determining the user engagement based on the user interactions. Moreover, the server arrangement being configured to display the indication of the aggregate user activity provides in-depth analysis and insights to the given user in a simplified manner. Furthermore, the server arrangement configured to determine the user engagement based on the indication of the aggregate user activity enhances the user experience of a given user by enabling the given user to make improved decision making based on the indication of the aggregate user activity displayed to the given user.

In the third aspect, the present disclosure provides a computer program product comprising a non-transitory machine-readable data storage medium having stored thereon program instructions that, when executed by a processor, cause the processor to implement the aforementioned method of the first aspect.

The present disclosure provides an aforementioned computer program product that improves efficiency in determining user engagement based on user interactions. Moreover displaying the indication of the aggregate user activity provides in-depth analysis and insights to the given user in a simplified manner. Furthermore, determining the user engagement based on the indication of the aggregate user activity enhances the user experience of a given user by enabling the given user to make improved decision making based on the indication of the aggregate user activity displayed, outputted or communicated via other means, such as through sound or API, to the given user.

The term “user” as used herein refers to an individual or an entity, as well as an algorithm, e.g. a Machine Learning (ML) algorithm, or another software program, that interacts with a computer-related application (such as a trading platform) to engage in various activities or perform various functions. Optionally, the plurality of users may comprise at least one of: individuals, organizations, individuals within any organization. Optionally, the plurality of users may interact with the application to engage in financial activities (such as trading commodities), when the computer-related application is the trading platform, to access market insights, identify interest in a particular market (such as type of green energy), geographies and time periods. Moreover, the plurality of users have unique access credentials (for example username and password) to log into the computer-related application securely. The term “user engagement” as used herein refers to an overall indication that indicates how the plurality of users interacts with the computer-related application (for example a trading system). Notably, the plurality of users interacts with the computer-related application to perform various activities (such as trading activities).

The term “user device” as used herein refers to an electronic device used by a user to access and interact with a computer-related application.

Optionally, the corresponding plurality of user devices may include personal computers, smartphones, tablets, laptops and the like. The corresponding plurality of user devices needs to go through an authentication process and only after authentication the corresponding plurality of user devices are connected to the application. Notably, each user device from amongst the corresponding plurality of user devices, is associated with a corresponding user from amongst the plurality of users. The term “user interactions” as used herein refers to the actions and activities that the plurality of users performs, through the graphical user interface executed at the corresponding plurality of user devices, when the plurality of users are using the computer-related application on the corresponding plurality of user devices. Typically, the user interactions may happen in various ways (such as clicking, scrolling, typing or any other activity that reflects the involvement of the plurality of users with the computer-related application). For example, a user interaction may be clicking a button on the GUI to buy a stock, or opening a tab on the GUI to check real-time prices of various stocks. Further examples could include detecting a user entering a parameter, or the user's mouse movements/mouseover interactions, as well as tracking a user's eye movements via camera, detecting a user's proximity to objects in a Virtual Reality (VR) environmentor, or detection of other peripheral activities.

Optionally, the user interactions comprise active user interactions. The term “active user interactions” as used herein refers to the interactions that the plurality of users performed in real-time while using the computer-related application. In this regard, active user interactions involve various actions performed in the real-time, such as making choices and placing orders (for example for some for wind or solar energy) in the real-time (for example, currently in Q4 of 2023). The active user interactions take place when a plurality of users engage with the computer-related application to perform task-oriented, information-driven or communication-related activities in the computer-related applications. A technical effect of the active user interactions is that the user interactions are recorded distinctively on the basis of the type of the user interaction compared against aggregated network interactions of the plurality of users.

Optionally, the user interactions comprise passive user interactions. The term “passive user interactions” as used herein refers to the user interactions of the plurality of users through the GUI, performed in past instances of time. The passive user interactions are collected separately from the active user interactions within the server arrangement. A technical effect of the user interactions comprising passive user interactions is that the passive user interactions enable to determine a history of the user engagement in the past instances of time. Beneficially, the plurality of users can compare the active user interactions with the passive user interactions for efficient and effective decision making, and thus, saving time and effort of the plurality of users.

The term “communication network” as used herein refers to a network that enables the plurality of user devices to exchange information with a server arrangement, related to activities performed on a computer- related application. Typically, the communication network plays a crucial role in connecting the corresponding plurality of user devices to the computer-related application across different locations and facilitating the exchange of data in real-time. The term “graphical user interface (GUI)” as used herein refers to a computer-generated interface that is rendered on the corresponding plurality of user devices to provide a way for the plurality of users to interact with the computer-related application on the corresponding plurality of user devices, using graphical elements (such as icons, button, images, and the like) displayed on respective display screens of the corresponding plurality of user devices. Typically, the GUI allows the plurality of users to interact with the computer-related application by manipulating the graphical elements on the respective display screens of the plurality of user devices. Moreover, the GUI enables the collection of information about how the computer-related application is being used by the plurality of users.

Optionally, the GUI is implemented as a trading system GUI. The term “trading system GUI” as used herein refers to that GUI which is rendered as such to incorporate features and functionalities specific to trading and financial activities and operate a trading system as the computer-related application. The trading system that is enabled via the trading system GUI comprises execution of buying or selling orders, and the like in financial markets. Typically, the trading system GUI serves as that user interface through which the plurality of users (such as traders) interact with and manage their trades within the trading system. The implementation of the GUI as the trading system GUI involves a combination of front-end design and back-end functionality to create a user-friendly platform for the traders to engage in financial markets. Beneficially, the trading system GUI provides a visual interface for the plurality of users to perform various actions such as placing trades, monitoring market data and executing trading strategies. A technical effect of the trading system GUI is that the plurality of users are able to use the trading system GUI to place orders, set order limits, provide real-time data regarding trading activities, physical and financial contracts and geographies. The trading system GUI helps the plurality of users to integrate technical analysis tools, allowing the plurality of users to perform chart analysis, create market sheets (showing active orders in a market), order and trade tickers, order entry dialog, identify potential trading opportunities and the like. Moreover, the trading system GUI may include features for managing and tracking the plurality of users' portfolios, current positions, gains or losses. The trading system GUI is integrated with the back-end functionality of the trading system. The back-end functionality handles the trade and order management, market data retrieval and core functionalities. The trading system GUI communicates with the back-end functionality to ensure accurate and timely execution of the trade orders. Moreover, the trading system GUI allows the plurality of users to easily navigate through the trading system.

Optionally, the GUI comprises a plurality of components, wherein each of the plurality of components is associated with a corresponding subset of data. The term “components” as used herein refers to the elements of the GUI that facilitate the plurality of users to interact with the application. In this regard, the plurality of components may include windows, icons, menus, toolbar, text field, buttons, tabs, dialog boxes, images and graphics. Moreover, the plurality of components work together to create a user-friendly experience while using the GUI, enabling the plurality of users to interact with the application efficiently. Notably, each of the plurality of components is present in the GUI to enable a corresponding user interaction. The term “subset of data” as used herein refers to a specific set of information that is associated with a given user interaction related to the computer-related application, using a given component. Subsequently, for each of the plurality of components, the corresponding subset of data is collected for performing the corresponding user interaction. Beneficially, the corresponding subset of data contains information regarding a usage of the given component with which the corresponding subset of data is associated, by the plurality of users. Notably, when the plurality of users is the given component, then that information is added to the corresponding subset of data associated with the given component. For example, for the given component being a button displayed in the GUI for the given user interaction of buying a stock, then the corresponding subset of data associated with the button may comprise information about how many times the button is pressed for buying the stock.

The term “user-interaction data” as used herein refers to information that indicates and represents the user interactions of the plurality of users, as they interact with the graphical user interface on the respective user devices while using the computer-related application. Optionally, the user-interaction data may include active user interactions' data and passive user interactions' data. Moreover, the computer-related application uses an event tracking mechanism to record the user-interaction data within the GUI. The inputs provided by the plurality of users via the GUI for performing the user-interactions are recorded as part of the user-interaction data.

Optionally, each data entry in the user-interaction data comprises a timestamp, a user identity, the corresponding subset of data, and a numerical weightage of a corresponding user interaction. The term “data entry” as used herein refers to an individual unit of data present in the user-interaction data, associated with the corresponding user interaction performed by a corresponding user. Moreover, each data entry in the user-interaction data is recorded for a corresponding user interaction of the corresponding user. The term “timestamp” as used herein refers to an information that indicates a specific date and time when a given data entry is recorded (such as a time and date for placing an order on the application). Typically, the timestamp includes information (such as a date, hour, minute and seconds) to provide a standardized format for consistency and easy interpretation of each data entry. Moreover, the timestamp helps to enter each data entry in the user-interaction data in a chronological order as per the occurrence of the corresponding user interaction for which each data entry is entered. The term “user identity” as used herein refers to a unique and distinct attribute that identifies that the corresponding user interaction is performed by which corresponding user from amongst the plurality of users. Notably, the user identity of each data entry associates that data entry to the given user who performs the user interaction for which that data entry is entered. It will be appreciated that each data entry comprising the corresponding subset of data enables to associate each data entry to the information related to the corresponding user interaction for which each data entry is entered in the user-interaction data. The term “numerical weightage” as used herein refers to assigning a numerical value to each data entry, to quantify the significance of the corresponding user interaction for which each data entry is entered in the user-interaction data. Typically, the numerical weightage is used to prioritize certain user interactions over the other user interactions. Beneficially, different types of user interactions are weighted differently based on the significance thereof for the plurality of users. For example, the data entry for the user interaction of moving a mouse pointer over a component of the GUI may be given the numerical weightage of 1. In another example, the data entry for the user interaction of clicking on a component of the GUI may be given the numerical weightage of 10. In yet another example, the data entry for the user interaction of performing an operation in the computer-related application may be given the numerical weightage of 100. Notably, each different type of the user interactions have different numerical weightage which may be refined over time. A technical effect is that each data entry in the user-interaction data contains detailed information of the corresponding user interaction for which that data entry is made.

Optionally, the step of collecting the user-interaction data comprises:
determining one or more components in which the user interactions occur; and
determining the one or more corresponding subsets of data associated with the one or more components, to be included in the user-interaction data.

In this regard, the term “one or more components” refers to those specific components from amongst the plurality of components, in which the user interactions occur using the one or more components. The computer-related application identifies the one or more components within the GUI executed at the corresponding plurality of user devices to perform the user interactions. Moreover, since each component of the GUI is associated with the corresponding subset of data, the one or more components are therefore associated with the one or more corresponding subsets of data. For example, a component in the form of an icon is present within the GUI for the user interaction of placing an order and another component in the form of another icon is present within the GUI for the user interaction specifying a quantity of the order. Subsequently, the icon for placing the order and the another icon for specifying the quantity of the order are associated with the corresponding subsets of data being how many users are placing the order, and what is the quantity the users are specifying for buying the order. The technical effect of the one or more corresponding subsets of data associated with the one or more components, being included in the user-interaction data is that the required information related to what kind of the user interactions and how the user interactions are taking place is being included in the user-interaction data. Beneficially, the user-interaction data comprising the one or more corresponding subsets of data associated with the one or more components enable to gather more detailed insights related to the user engagement from the user-interaction data.

Optionally, the step of collecting the user-interaction data comprises:
determining a type of interaction for each of the user interactions; and
determining a numerical weightage for each of the user interactions based on the determined type of interaction for each of the user interactions, to be included in the user-interaction data. In this regard, the term “type of the interaction” as used herein refers to a parameter that defines a nature of the user interaction. Notably, the type of interaction for each of the user interactions is determined based on a purpose or a function in the computer-related application for which that user interaction is performed. Additionally, each of the user interactions have a different numerical weightage as a corresponding function or purpose for which that user interaction is performed has a different significance. The significance of the corresponding function or purpose for which each of the user interactions is performed is determined by the type of interaction for each of the user interactions. Subsequently, the numerical weightage for each of the user interactions is thus, determined based on the determined type of interaction for each of the user interactions. Notably, the numerical weightage is used to prioritize certain user interactions over the other user interactions. For example, moving a mouse pointer over a component of the GUI may be given the numerical weightage of 1, Whereas clicking on another component of the GUI may be given the numerical weightage of 10. The numerical weightage for each of the user interactions provides data related to the importance of each of the user interactions and differentiates between each of the user interactions on the basis of the importance of each of the user interactions. A technical effect is that by identifying the type of interaction for each of the user interactions, the user-interaction data is collected in a structured format which allows to determine the numerical weightage for each of the user interactions easily.

Optionally, the method further comprising anonymizing the user-interaction data. The term “anonymizing” as used herein refers to the process of removing or modifying any confidential information related to privacy of the plurality of users, from the user-interaction data. In this regard, the anonymization of the user-interaction data ensures that the identity of the plurality of users is not identifiable. Beneficially, the anonymization of the user-interaction data may be applied at different stages of the collection of the user-interaction data. The anonymization of the user-interaction data is done to protect the privacy of the plurality of users and comply with data protection regulations. Moreover, the anonymization of the user-interaction data is crucial for an analysis of behaviour of the plurality of users without a need of identification of any specific user amongst the plurality of users. A technical effect is that the anonymization of the user-interaction data adds an extra layer of security, reducing the risk of the user-interaction data breaches or misuse of the user-interaction data by any third party.

The term “analyzing” as used herein refers to a process of examining the user-interaction data to understand a behaviour and patterns of the plurality of users (such as, market trends). In this regard, the analysis of the user-interaction data employs various analytical methods such as statistical analysis, data visualization, machine learning techniques and the like. The analysis of the user-interaction data enables one to uncover meaningful patterns of trade, identify a location and geographies and how the plurality of users engages within the GUI, when the computer-related application is the trading system. The term “aggregate user activity” as used herein refers to a consolidation of the user interactions of the plurality of users, into a collective or summarized form. For example, counting the number of clicks on each icon within the GUI, by the plurality of users. The aggregate user activity provides an overview of the overall behaviour of the plurality of users. Notably, the aggregate user activity is determined from the analysis of the user-interaction data. Such user-interaction data is derived from an array of information as opposed to a single user interaction with a single contract, e.g. related interactions with other contracts, times, geographies etc. will also be identified and analysed. The aggregate user activity provides a real-time heat map of the user interactions within the GUI of the application. Moreover, the aggregate user activity may be represented in the form of charts or graphs, determined from the analysis of the user-interaction data. Moreover, the aggregate user activity draws the attention of the given user to those features in the computer-related application that are gaining an interest of other users from amongst the plurality of users. Beneficially, the analysis of the user-interaction data provides real-time insights with regards to what user engagement is likely to occur and that may be of interest for the given user. Optionally, the features that might gain the interest of the given user could be, prices (e.g. firm, implied, indicative, synthetic), physical and financial contracts, commodities, implied prices, time periods and geographies, at varying granularities and in various combinations, when the computer-related application is the trading system.

Optionally, the step of analyzing the user-interaction data comprises determining the aggregate user activity within a market and within a time interval. The term “market” as used herein refers to a specific business industry or domain related to which the analyzed user-interactions occur. For example, if the computer-related application is related to the trading system, the market may refer to a financial market. Moreover, analyzing the user interactions within the specific market provides context for the analysis, such as understanding unique characteristics and features in the user interactions associated with the market. The term “time interval” as used herein refers to an interval of time during which the user interactions are measured and analyzed. In this regard, the time interval may be hours, days, weeks, minutes and the like. The aggregate user activity performed during the given time interval indicates market trends, patterns and variation in the plurality of users' behaviour in interacting with the computer-related application implemented as the trading system. Beneficially, the aggregate user activity within the time interval provides for a temporal understanding of changes in the user interactions over a period of time in the time interval. The technical effect of determining the aggregate user activity within the market and within the time interval is to derive insights and understand the user interactions within the market and over the time interval to further understand trends and patterns in the user engagement.

Optionally, the step of analyzing the user-interaction data also comprises profiling users in order to identify potential bad actors based on their user activity. The term “bad actor” as used herein refers to a user who is involved in potentially harmful, illegal, or otherwise unauthorized activities, such as hacking or screen scraping. Analysis of the user-interaction data can help identify normal user activity based on trends in said users' behaviour in order to build a profile of normal user activity. As such, unusual behaviour can also be identified. The disparity between such behaviour can therefore be used to help identify new versus established users, humans versus non humans, hackers versus non-hackers, screen scrapers versus non screen scrapers and the like. The technical effect of profiling user activity is that it enables security profiling, thus providing a means of combating bad actors.

Optionally, the determined aggregate user activity is associated with trade activity. The term “trade activity” as used herein refers to the actions related to an exchange of financial instruments (such as stocks, commodities and the like) between buyers and sellers, within a context of financial markets. Typically, the plurality of users' behaviour via the user engagement activity is reflected in the trade activity. Moreover, the analysis of the user interactions correlates the aggregate user activity within the computer-related application, with the specific actions related to the trading activities. Typically, a connection is established between the user interactions and specific actions related to the trading within the computer-related application. A technical effect of the association of the aggregate user activity with the trade activity is that it provides an understanding of the plurality of users' navigation and engagement within the computer-related application in relation to the trade activity. This association enables users to make data-driven decisions and optimize the trading activity for the given user based on the association of the aggregate user activity with the trade activity. Optionally, the trade activity is measured by a volume of transactions, wherein the trade activity increases with a high volume of transactions and similarly, the trade activity decreases with a lower volume of transactions.

Optionally, the trade activity comprises automated trade activity. The term “automated trade activity” as used herein refers to an execution of the exchange of financial instruments using automated instructions or algorithms. Typically, instead of manual intervention by the plurality of users, the automated trade activity relies on pre-programmed instructions to analyze the market conditions, make trading decisions and execute trading orders (such as identify interest in a particular market), based on predefined requirements of the plurality of users. The technical effect of such automated trade activity is that it helps contribute to market liquidity and efficiency via its speed and accuracy.

Optionally, the step of analyzing the user-interaction data comprises normalizing the aggregate user activity based on a time. The term “normalizing” as used herein refers to a process of adjusting the user-interaction data to a common scale or standard. The normalization may involve adjusting or scaling the user-interaction data to account for variations in time intervals (for example, hours, days or week) and contract types. Typically, the normalization provides a standardized view of the user interactions, making analysis of the user-interaction data across different time periods possible. Beneficially, normalizing the aggregate user activity based on the time ensures that the aggregate user activity is represented consistently across different time intervals. Notably, for normalizing the aggregate user activity the user-interaction data is segmented into time intervals (such as dividing the user-interaction data into hourly, weekly or daily time segments) and a normalization formula is applied to segmented aggregate user activity to scale metrics of the aggregated user activity based on the duration of each time interval. A technical effect of the step of analyzing the user-interaction data comprising normalizing the aggregate user activity based on the time is that it allows for a fair and meaningful comparison of the metrics of aggregate user activity across the different time intervals. In this regard, normalizing the aggregate user activity based on the time is crucial for identifying the trends in the financial market and understanding evolved behaviour of the plurality of users, over the time.

Optionally, the step of analyzing the user-interaction data comprises correlating a first subset of data to a second subset of data in the user-interaction data. The term “first subset of data” as used herein refers to that corresponding subset of data associated with a first component of the GUI (such as the corresponding subset of data related to a specific icon of the GUI to place an order by the plurality of users). The term “second subset of data” as used herein refers to that corresponding subset of data associated with a second component of the GUI (such as the corresponding subset of data related to another icon of the GUI to specify a quantity of the order placed by the plurality of users). Notably, correlating the first subset of data to the second subset of data involves analyzing patterns and relations in the first subset of data, analyzing patterns and relations in the second subset of data and subsequently, mapping the patterns and relations in the first subset of data with the patterns and relations in the second subset of data. It will be appreciated that correlating the first subset of data to the second subset of data enables the identification of potential connections, dependencies, influences, and the like between the first subset of data and the second subset of data. A technical effect of correlating the first subset of data to the second subset of data is that relationships and associations between a first user interaction associated with the first subset of data and a second user interaction associated with the second subset of data are effectively identified.

Optionally, the step of analyzing the user-interaction data comprises applying a machine-learning model on the user-interaction data, wherein the machine-learning model is trained using a historical user-interaction data. The term “machine-learning model” as used herein refers to an automated model with a set of algorithms that can learn patterns, relationships and insights from the user-interaction data. Typically, the machine-learning model is designed to process the user-interaction data and make predictions, based on the learned patterns, relationships, and insights. The term “historical user-interaction data” as used herein refers to past records of the user interactions of the plurality of users, with the GUI within the computer-related application. Typically, the historical user-interaction data includes information of the user interactions of the plurality of users in the past, such as features used, and services availed within the computer-related application by the plurality of users. Moreover, the historical user-interaction data serve as a training data set for the machine-learning model. The machine-learning model learns the patterns and relationships in the historical user-interaction data and fine- tuned parameters of the machine-learning model to improve the accuracy in analyzing the user-interaction data. A technical effect of applying the machine-learning model on the user-interaction data is that the machine learning model is able to gather detailed in-depth patterns, relationships, and insights in the user-interaction data based on the training from the historical user-interaction data and subsequently, predict the features of the computer-related application that might be of interest for the given user.

The term “indication” as used herein refers to a representation of the aggregate user activity that provides the patterns, behaviours, and insights in the aggregate user activity to the given user. Optionally, the indication may be in the form of a visual representation (such as a chart, graph, heat map, animation, graphic, icon etc.), reflecting the patterns, behaviours, and insights in the aggregate user activity to the given user visually. The term “given user” as used herein refers to any specific user amongst the plurality of users that wants to determine the user engagement. The term “given user device” as used herein refers to a corresponding user device amongst the corresponding plurality of user devices, that the given user uses to interact with the computer-related application. Notably, the indication of the aggregate user activity includes results obtained from the analysis of the aggregate user activity. It will be appreciated that the patterns, behaviours, and insights in the aggregate user activity are also indicative of the user engagement. Subsequently, displaying the indication of the aggregate user activity within the GUI to the given user at the given user enables the user to determine the user engagement.

Optionally, the step of displaying the indication of the aggregate user activity within the GUI comprises highlighting an element of the GUI. The term “element” as used herein refers to a specific component, feature or section within the GUI of the computer-related application, that has significance based on the indication of the aggregate user activity. For example, the element may be an icon showing active orders in a market or order and trade tickers. Notably, highlighting the element draws the attention of the given user to the element while determining the user engagement. Optionally, the highlighting of the element may be achieved through visual effects (such as changing a color, adding a border, adding animations, a time-based pulsing effect, heartbeats, accelerators, and the like for the element) to make the element stand out to the given user. The relevance or importance of a particular element can also be displayed to the user via the effect. For example, a slower heartbeat effect could indicate a lower degree of relevance, whereas a faster heartbeat could indicate a higher degree of relevance. A technical effect of highlighting the element of the GUI is that the user is able to easily identify elements having a high significance and subsequently, to determine the user engagement.

Optionally, the step of displaying the indication of the aggregate user activity within the GUI comprises displaying an alert. The term “alert” as used herein refers to a visual or auditory notification which draws the given user's attention to a specific feature or information in the GUI. In this regard, the alert is used to communicate updates, notifications or events that are important to the given user. Moreover, a triggering event related to the aggregate user activity (such as a sudden surge in the user interactions with a specific feature of the GUI) which requires the alert to be generated is identified and based on the identified event and causes the alert to be displayed. Optionally, the alert is displayed to the plurality of users in a noticeable way (for example a pop-up window, a banner, a flashing icon, a sound and the like). A technical effect of displaying the alert is that the given user is instantaneously alerted about any significant event that takes place related to the aggregated user active and thus enables the determination of user engagement more effectively. Beneficially, the alert contributes to determining improved user engagement by notifying the given user of significant changes or events in the aggregated user activity with the computer-related application.

Optionally, the step of displaying the indication of the aggregate user activity within the GUI comprises normalizing the aggregate user activity based on a user activity of the given user. The term “normalizing” as used herein refers to the process of normalization by scaling or adjusting the information of the user interactions in the aggregate user activity to a common scale in accordance with the user activity of the given user. The normalization of the aggregate user activity ensures fair comparisons by removing the influence of different scales that are not related to the user activity of the given user. The term “user activity” as used herein refers to information that indicates the user interactions of the given user with the GUI of the computer-related application. A technical effect of normalizing the aggregate user activity based on the user activity of the given user is that the indication of the aggregate user activity is personalized for the given user based on the user activity of the given user to ensure that the user engagement that is subsequently determined is also personalized for the user.

The present disclosure also relates to the system as described above. Various embodiments and variants disclosed above, with respect to the aforementioned method, apply mutatis mutandis to the system.

The term “server arrangement” as used herein refers to a computational element that is operable to execute instructions of the system. It will be appreciated that the term “server arrangement” refers to “one server” in some implementations, and “a plurality of servers” in other implementations. Examples of the server arrangement include, but are not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the server arrangement may refer to one or more individual servers, processing devices and various elements associated with a processing device that may be shared by other processing devices. Additionally, one or more individual processors, processing devices and elements are arranged in various architectures for responding to and processing the instructions that execute the instructions of the system.

The present disclosure also relates to the computer program product as described above. Various embodiments and variants disclosed above, with respect to the aforementioned method and the aforementioned system, apply mutatis mutandis to the computer program product.

### DETAILED DESCRIPTION OF THE DRAWINGS

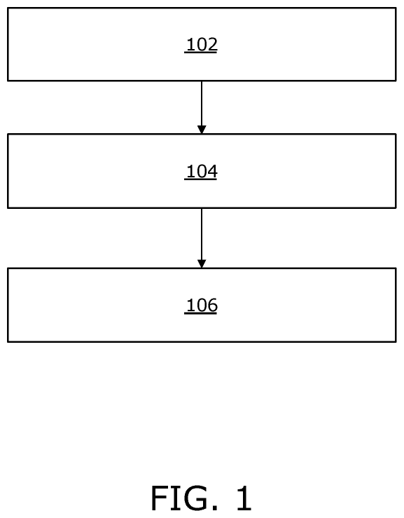

Referring to FIG. 1 illustrated is a method 100 for determining user engagement based on user interactions, in accordance with an embodiment of the present disclosure. At step 102, user interaction data representative of the user interactions of a plurality of users with a graphical user interface (GUI) executed at a corresponding plurality of user devices, is collected via a communication network. At step 104, the user-interaction data is analyzed to determine an aggregate user activity within the GUI. At step 106, an indication of the aggregate user activity within the GUI is displayed, outputted or communicated via other means, such as through sound or API, to a given user at a given user device from amongst the corresponding plurality of user devices, for determining the user engagement.

The aforementioned steps are only illustrative and other alternatives can also be provided where one or more steps are added, one or more steps are removed, or one or more steps are provided in a different sequence without departing from the scope of the claims herein.

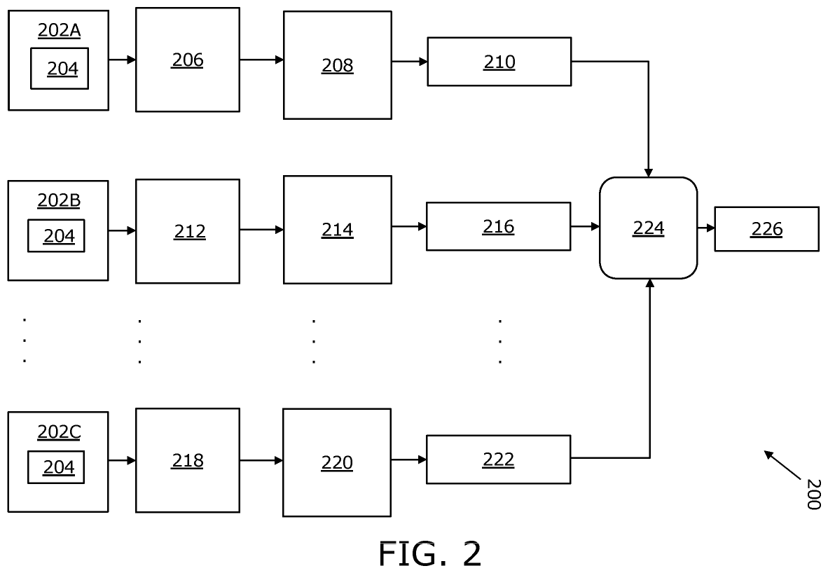

Referring to FIG. 2 illustrated is a schematic depicting an implementation of a method for determining user engagement based on user interactions, in accordance with an embodiment of the present disclosure. As shown, a first user device 202A amongst a corresponding plurality of user devices 202A-C comprises a graphical user interface (GUI) 204. At step 206, the first user device 202A interacts with a computer-related application via the GUI 204 and subsequently, a first user interaction of the first user device 202A with the computer-related application includes a timestamp, a topic, a type of interaction and a base significance. At step 208, a numerical weightage is assigned to the first user interaction, on a basis of the type of interaction, the topic, the timestamp and the like. At step 210, significance of the first user interaction is determined on the basis of a value or a score given to the first user interaction. Similarly, a second user device 202B amongst the corresponding plurality of user devices 202A-C comprises the graphical user interface (GUI) 204. At step 212, the second user device 202B interacts with the computer-related application via the GUI 204 and subsequently, a second user interaction of the second user device 202B with the computer-related application includes the timestamp, the topic, the type of interaction and the base significance. At step 214, the numerical weightage is assigned to the second user interaction, on a basis of the type of interaction, the topic, the timestamp and the like. At step 216, the significance of the second user interaction is determined on a basis of the value or the score given to the second user interaction. Similarly, as shown, a third user device 202C amongst the corresponding plurality of user devices 202A-C comprises the graphical user interface (GUI) 204. At step 218, the third user device 202B interacts with the computer-related application via the GUI 204 and subsequently, a third user interaction of the third user device 202B with the computer-related application includes the timestamp, the topic, the type of interaction and the base significance. At step 220, the numerical weightage is assigned to the third user interaction, on a basis of the type of interaction, the topic, the timestamp and the like. At step 222, the significance of the third user interaction is determined on a basis of the value or the score given to the third user interaction. At step 224, the significance of the first user interaction, the second user interaction, and the third user interaction are combined for comparison. At step 226, a highlight of an element of the GUI 204 which has a highest significance from amongst the first user interaction, the second user interaction, and the third user interaction, along with an alert regarding the same, are shown to a given user at a given user device.

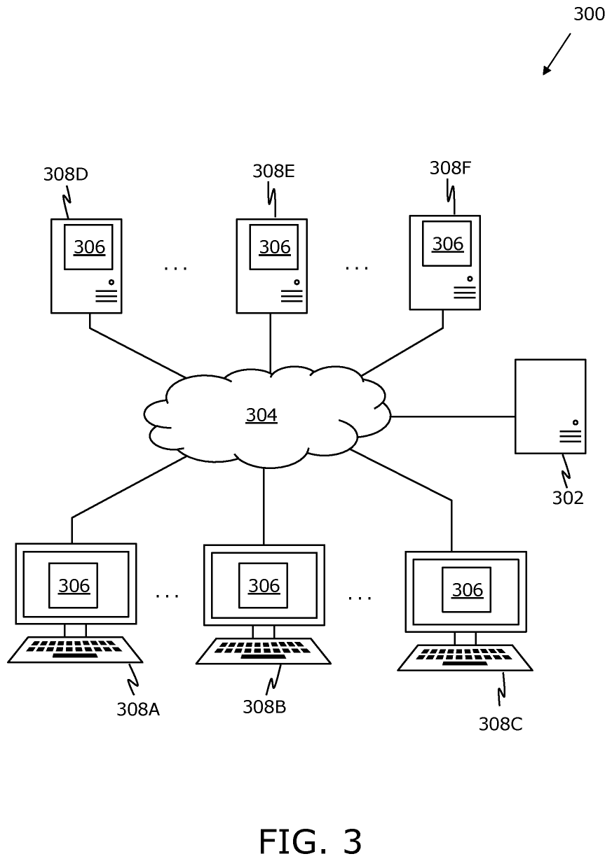

Referring to FIG. 3 illustrated is a system 300 for determining user engagement based on user interactions, in accordance with an embodiment of the present disclosure. As shown, the system 300 comprises a server arrangement 302 configured to collect via a communication network 304, user-interaction data representative of the user interactions of a plurality of users with a graphical user interface (GUI) 306 executed at a corresponding plurality of user devices 308A-F. Moreover, the server arrangement 302 is configured to analyze the user-interaction data to determine an aggregate user activity within the GUI 306. Furthermore, the server arrangement 302 is configured to display an indication of the aggregate user activity within the GUI 306 to a given user at a given user device 308F from amongst the corresponding plurality of user devices 308A-F, to determine the user engagement. In an implementation, the user devices 308A-C from amongst the corresponding plurality of user devices 308A-F are market participant computers, the user device 308D from amongst the corresponding plurality of user devices 308A-F is a broker computer, and the user devices 308E from amongst the corresponding plurality of user devices 308A-F is an exchange computer.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for determining user engagement based on user interactions, comprising:
collecting via a communication network, user-interaction data representative of the user interactions of a plurality of users with a graphical user interface (GUI) executed at a corresponding plurality of user devices;
analyzing the user-interaction data to determine an aggregate user activity within the GUI, wherein analyzing the user-interaction data comprises applying a machine-learning model on the user-interaction data, wherein the machine-learning model is trained using historical user-interaction data, and wherein the historical user-interaction data includes past records of the user interactions of the plurality of users with the GUI; and
displaying an indication of the aggregate user activity within the GUI to a given user at a given user device from amongst the corresponding plurality of user devices, for determining the user engagement.

2. The method of claim 1, wherein the GUI comprises a plurality of components, and wherein each of the plurality of components is associated with a corresponding subset of data.

3. The method of claim 2, wherein the step of collecting the user-interaction data comprises:
determining one or more components in which the user interactions occur; and
determining the one or more corresponding subsets of data associated with the one or more components, to be included in the user-interaction data.

4. The method of claim 1, wherein the step of collecting the user-interaction data comprises:
determining a type of interaction for each of the user interactions; and
determining a numerical weightage for each of the user interactions based on the determined type of interaction for each of the user interactions, to be included in the user-interaction data.

5. The method of claim 2, wherein each data entry in the user-interaction data comprises a timestamp, a user identity, the corresponding subset of data, and a numerical weightage of a corresponding user interaction.

6. The method of claim 1, wherein the user interactions comprise active user interactions, wherein the active user interactions are user interactions performed by the plurality of users in real-time.

7. The method of claim 1, wherein the user interactions comprise passive user interactions, wherein the passive user interactions are user interactions performed by the plurality of users, through the GUI, in past instances of time.

8. The method of claim 1, further comprising anonymizing the user-interaction data, wherein anonymizing the user-interaction data includes removing or modifying confidential information related to privacy of the plurality of users, from the user-interaction data.

9. The method of claim 1, wherein the step of analyzing the user-interaction data comprises determining the aggregate user activity within a market and within a time interval.

10. The method of claim 1, wherein the GUI is implemented as a trading system GUI.

11. The method of claim 10, wherein the determined aggregate user activity is associated with trade activity.

12. The method of claim 11, wherein the trade activity comprises automated trade activity.

13. The method of claim 1, wherein the step of analyzing the user-interaction data comprises normalizing the aggregate user activity based on a time, wherein normalizing the aggregate user activity includes adjusting the user-interaction data to a common scale or standard, and wherein normalizing the aggregate user activity further includes adjusting the user-interaction data to account for variations in time intervals.

14. The method of claim 1, wherein the step of analyzing the user-interaction data comprises correlating a first subset of data to a second subset of data in the user-interaction data.

15. (canceled)

16. The method of claim 1, wherein the step of displaying the indication of the aggregate user activity within the GUI comprises highlighting an element of the GUI.

17. The method of claim 1, wherein the step of displaying the indication of the aggregate user activity within the GUI comprises displaying an alert.

18. The method of claim 1, wherein the step of displaying the indication of the aggregate user activity within the GUI comprises normalizing the aggregate user activity based on a user activity of the given user.

19. A system for determining user engagement based on user interactions, comprising a server arrangement configured to:
collect via a communication network, user-interaction data representative of the user interactions of a plurality of users with a graphical user interface (GUI) executed at a corresponding plurality of user devices;
analyze the user-interaction data to determine an aggregate user activity within the GUI, wherein analyzing the user-interaction data comprises applying a machine-learning model on the user-interaction data, wherein the machine-learning model is trained using historical user-interaction data, and wherein the historical user-interaction data includes past records of the user interactions of the plurality of users with the GUI; and
display an indication of the aggregate user activity within the GUI to a given user at a given user device from amongst the corresponding plurality of user devices, to determine the user engagement.

20. A computer program product comprising a non-transitory machine-readable data storage medium having stored thereon program instructions that, when executed by a processor, cause the processor to implement the method of claim 1.
